(19) United States
(12) Patent Application Publication
(10) Pub. No.: US 2023/0230320 A1
(43) Pub. Date: Jul. 20, 2023

(54) ARTIFICIAL INTELLIGENCE DEVICE AND OPERATING METHOD THEREOF

(71) Applicant: LG ELECTRONICS INC., Seoul (KR)

(72) Inventors: Youngjoo CHO, Seoul (KR); Sookhyun YANG, Seoul (KR)

(73) Assignee: LG ELECTRONICS INC., Seoul (KR)

(21) Appl. No.: 17/721,161

(22) Filed: Apr. 14, 2022

(30) Foreign Application Priority Data
Jan. 17, 2022 (WO) PCT/KR2022/000857

(51) Int. Cl. G06T 17/20; G06V 40/16; G06T 13/40; G06T 7/73

(52) U.S. Cl. CPC G06T 17/20; G06V 40/168; G06T 13/40; G06T 7/73; G06T 2207/30201

(57) ABSTRACT

An artificial intelligence device can include a display configured to display an avatar image, a processor configured to detect a user's face region from an image received from a camera, extract a preset number of feature points from the detected face region, and transmit information about the extracted feature points to a graphic engine, and the graphic engine configured to output, to the display, an avatar face image corresponding to the face region based on the information about the feature points.

### CROSS-REFERENCE TO RELATED APPLICATIONS

Pursuant to 35 U.S.C. § 119, this application claims the benefit of an earlier filing date and right of priority to International Application No. PCT/KR2022/000857, filed on Jan. 17, 2022, the contents of which are hereby incorporated by reference herein in its entirety.

### BACKGROUND

The present disclosure relates to an artificial intelligence device, and more particularly, to an artificial intelligence device for a metaverse.

Metaverse is a compound word of meta meaning beyond and virtual, and universe meaning world, and represents a virtual world. Metaverse is a system that enables political, economic, social, and cultural activities in the virtual world.

Recently, as telecommuting has become more active, metaverse is being used to communicate between employees.

In metaverse, users also express themselves through avatars, which are alter egos of the users.

Conventionally, in order to realistically display a change in a user's facial expression, a captured user video stream is used and reflected in the avatar.

However, in this case, there is a problem in that data capacity of the user's video stream increases, and delay occurs when the video stream is reflected in the avatar.

### SUMMARY

The present disclosure aims to reflect on an avatar without delay using only a preset number of feature points from a detected user face region.

An embodiment of the present disclosure aims to provide a realistic avatar by reflecting a change in a user face on an avatar face in real time.

An artificial intelligence device according to an embodiment of the present disclosure can include a display configured to display an avatar image, a processor configured to detect a user's face region from an image received from a camera, extract a preset number of feature points from the detected face region, and transmit information about the extracted feature points to a graphic engine, and the graphic engine configured to output, to the display, an avatar face image corresponding to the face region based on the information about the feature points.

### BRIEF DESCRIPTION OF THE DRAWINGS

FIG. 1 illustrates an artificial intelligence (AI) device according to an embodiment of the present disclosure.

FIG. 2 illustrates an AI server according to an embodiment of the present disclosure.

FIG. 3 illustrates an AI system according to an embodiment of the present disclosure.

FIG. 4 illustrates an AI device according to another embodiment of the present disclosure.

FIG. 5 is a ladder diagram for describing an operating method of a system according to an embodiment of the present disclosure.

FIG. 6 is a view for describing a process of extracting a plurality of feature points from an image, according to an embodiment of the present disclosure.

FIG. 7 is a view for describing an avatar face mesh according to an embodiment of the present disclosure.

FIG. 8 is a flowchart for describing a process of determining an avatar face mesh matching a user feature point set and displaying an avatar face image corresponding to the determined avatar face mesh, according to an embodiment of the present disclosure.

FIG. 9 is a view for describing an example of reflecting a change in an obtained user face through an avatar face image in real time, according to an embodiment of the present disclosure.

FIG. 10 is a view for describing an operating method of an AI device according to an embodiment of the present disclosure.

### DETAILED DESCRIPTION OF THE EMBODIMENTS

### Artificial Intelligence (AI)

AI refers to the field of research on artificial intelligence or methodologies that can create the artificial intelligence, and machine learning refers to the field that defines various problems dealt with in the field of AI and studies methodologies to solve them. Machine learning is also defined as an algorithm that improves the performance of a certain task through constant experience.

An artificial neural network (ANN) is a model used in machine learning, and may refer to an overall model having problem-solving ability, which includes artificial neurons (nodes) that form a network by combining synapses. The ANN may be defined by a connection pattern between neurons of different layers, a learning process of updating model parameters, and an activation function of generating an output value.

The ANN may include an input layer, an output layer, and optionally one or more hidden layers. Each layer includes one or more neurons, and the ANN may include neurons and synapses connecting neurons. In the ANN, each neuron may output a function value of an activation function for input signals, weights, and biases, which are input through synapses.

The model parameters refer to parameters determined through learning, and include the weights of synaptic connections and the biases of neurons. Hyperparameter refers to a parameter that must be set before learning in a machine learning algorithm, and includes a learning rate, number of iterations, mini-batch size, initialization function, and the like.

The purpose of learning of the ANN may be to determine a model parameter that minimizes a loss function. The loss function may be used as an index for determining optimal model parameters in the learning process of the ANN.

### Definition of Machine Learning

Machine learning is a branch of AI and is the field of study that gives computers the ability to learn without an explicit program.

Specifically, machine learning may be said to be a technology to study and build a system for performing learning and prediction based on empirical data and improving its own performance, and an algorithm therefor.

Algorithms of machine learning build specific models so as to make predictions or decisions based on input data, rather than executing strictly set static program instructions.

The term “machine learning” may be used interchangeably with the term “machine learning”.

With regard to how to classify data in machine learning, many machine learning algorithms have been developed. Decision tree, Bayesian network, support vector machine (SVM), and ANN are representative examples.

The decision tree is an analysis method for performing classification and prediction by charting decision rules in a tree structure.

The Bayesian network is a model that expresses the probabilistic relationship (conditional independence) between multiple variables in a graph structure. The Bayesian network is suitable for data mining through unsupervised learning.

The SVM is a model of supervised learning for pattern recognition and data analysis, and is mainly used for classification and regression analysis.

The ANN is a model of the operating principle of biological neurons and the connection relationship between neurons, and is an information processing system in which a plurality of neurons called nodes or processing elements are connected in the form of a layer structure.

The ANN is a model used in machine learning, and it is a statistical learning algorithm inspired by neural networks in biology (especially the brain in the central nervous system of animals) in machine learning and cognitive science.

Specifically, the ANN may refer to an overall model having the problem-solving ability, wherein artificial neurons (nodes) forming a network by combining synapses changes the strength of synaptic bonding through learning.

The ANN may be used interchangeably with a neural network.

The ANN may include a plurality of layers, each of which may include a plurality of neurons. In addition, the ANN may include neurons and synapses connecting neurons.

In general, the ANN may be defined by the following three factors, that is, (1) the connection pattern between neurons in different layers, (2) the learning process of updating the weight of the connection, and (3) the activation function of generating an output value from the weighted sum of the input received from a previous layer.

The ANN may include network models such as deep neural network (DNN), recurrent neural network (RNN), bidirectional recurrent deep neural network (BRDNN), multilayer perceptron (MLP), convolutional neural network (CNN), but the present disclosure is not limited thereto.

In the present specification, the term “layer” may be used interchangeably with the term “layer”.

The ANN is divided into single-layer neural networks and multi-layer neural networks according to the number of layers.

A typical single-layer neural network includes an input layer and an output layer.

In addition, a typical multi-layer neural network includes an input layer, one or more hidden layers, and an output layer.

The input layer is a layer that receives external data, the number of neurons in the input layer is equal to the number of input variables, and the hidden layer is located between the input layer and the output layer, receives a signal from the input layer, extracts features, and transmits the extracted features to the output layer. The output layer receives a signal from the hidden layer and outputs an output value based on the received signal. The input signal between neurons is multiplied by each connection strength (weight) and then summed. If this sum is greater than the threshold of the neuron, the neuron is activated and the output value obtained through the activation function is output.

On the other hand, the DNN including a plurality of hidden layers between an input layer and an output layer may be a representative ANN that implements deep learning, which is a type of machine learning technology.

The term “deep learning” may be used interchangeably with the term “deep learning”.

The ANN may be trained by using training data.

Training refers to a process of determining parameters of the ANN by using training data so as to achieve objectives such as classification, regression, or clustering of input data.

A representative example of parameters of the ANN may include a weight applied to a synapse or a bias applied to a neuron.

The ANN that is trained by the training data may classify or cluster input data according to a pattern of the input data.

On the other hand, the ANN that is trained by using training data may be referred to as a trained model in the present specification.

A training method of the ANN will be described below.

The training method of the ANN may be broadly classified into supervised learning, unsupervised learning, semi-supervised learning, and reinforcement learning.

The supervised learning is a method of machine learning for inferring one function from training data. In the inferred function, outputting continuous values is referred to as regression, and predicting and outputting the class of an input vector is referred to as classification.

In the supervised learning, the ANN is trained in a state in which a label for training data is given.

The label may refer to a correct answer (or a result value) that the ANN should infer when training data is input to the ANN.

In the present specification, when training data is input, the correct answer (or result value) that the ANN should infer is referred to as a label or labeling data.

In addition, in the present specification, setting the label on the training data for the training of the ANN is referred to as labeling the labeling data on the training data.

In this case, the training data and the label corresponding to the training data may constitute one training set, and may be input to the ANN in the form of the training set.

On the other hand, the training data represents a plurality of features, and labeling the training data may mean that the features represented by the training data are labeled. In this case, the training data may represent the features of the input object in a vector form.

The ANN may infer a function for an association relationship between the training data and the labeling data by using the training data and the labeling data. The parameters of the ANN may be determined (optimized) through evaluation of the function inferred from the ANN.

The unsupervised learning is a type of machine learning in which no labels are given to training data.

Specifically, the unsupervised learning may be a learning method of training the ANN to find and classify patterns in training data itself, rather than an association relationship between training data and a label corresponding to the training data.

Examples of the unsupervised learning include clustering or independent component analysis.

In the present specification, the term “clustering” may be used interchangeably with the term “clustering”.

Examples of the ANN using the unsupervised learning include a generative adversarial network (GAN) and an autoencoder (AE).

The GAN is a machine learning method in which two different AIs, that is, a generator and a discriminator, compete to improve performance.

In this case, the generator is a model for creating new data, and may generate new data based on original data.

In addition, the discriminator is a model for recognizing a pattern of data, and may discriminate whether input data is original data or new data generated by the generator.

The generator may learn by receiving data that has not been deceived by the discriminator, and the discriminator may learn by receiving data deceived from the generator. Accordingly, the generator may evolve to deceive the discriminator as best as possible, and the discriminator may evolve to distinguish the original data and the data generated by the generator well.

The AE is a neural network that aims to reproduce the input itself as an output.

The AE includes an input layer, at least one hidden layer, and an output layer.

In this case, since the number of nodes in the hidden layer is less than the number of nodes in the input layer, the dimension of data is reduced, and thus compression or encoding is performed.

In addition, data output from the hidden layer is input to the output layer. In this case, since the number of nodes of the output layer is greater than the number of nodes of the hidden layer, the dimension of data is increased, and decompression or decoding is performed accordingly.

On the other hand, the AE controls the neuron's connection strength through learning, so that the input data is expressed as hidden layer data. The hidden layer expresses information with fewer neurons than the input layer. Being able to reproduce input data as an output may mean that the hidden layer found and expressed hidden patterns from the input data.

The semi-supervised learning is a type of machine learning, and may refer to a learning method using both labeled training data and unlabeled training data.

As one of the semi-supervised learning technique, there is a technique in which a label of unlabeled training data is inferred and then learning is performed using the inferred label. This technique may be usefully used when the cost of labeling is large.

The reinforcement learning is a theory that, given an environment in which the agent can decide what action to take at every moment, it can find the best way through experience without data.

The reinforcement learning may be mainly performed by a Markov decision process (MDP).

The MDP will be described below. First, an environment in which information necessary for the agent to take the next action is configured is given. Second, it defines how the agent will behave in that environment. Third, it defines what the agent will be rewarded for when it does something well and what the agent will be penalized for when it does not. Fourth, the optimal policy is derived by repeating experiences until future rewards reach the highest point.

The structure of the ANN is specified by the model configuration, activation function, loss function or cost function, learning algorithm, optimization algorithm, etc. A hyperparameter may be preset before learning, and then a model parameter may be set through learning to specify the content thereof.

For example, factors for determining the structure of the ANN may include the number of hidden layers, the number of hidden nodes included in each hidden layer, an input feature vector, a target feature vector, etc.

The hyperparameter includes a plurality of parameters that must be initially set for learning, such as initial values of model parameters. The model parameters include a plurality of parameters to be determined through learning.

For example, the hyperparameter may include an inter-node initial weight value, an inter-node initial bias value, a mini-batch size, a number of learning repetitions, a learning rate, etc. In addition, the model parameters may include inter-node weights, inter-node biases, etc.

The loss function may be used as an index (reference) for determining the optimal model parameter in the training process of the ANN. In the ANN, training refers to the process of manipulating model parameters so as to reduce the loss function, and the purpose of training may be to determine the model parameters that minimize the loss function.

The loss function may mainly use a mean squared error (MSE) or a cross entropy error (CEE), but the present disclosure is not limited thereto.

The CEE may be used when the correct answer label is one-hot encoded. The one-hot encoding is an encoding method in which the correct label value is set to 1 only for neurons corresponding to the correct answer, and the correct answer label value is set to 0 for neurons that do not have the correct answer.

In the machine learning or deep learning, the learning optimization algorithm may be used to minimize the loss function, and the learning optimization algorithm may include gradient descent (GD), stochastic gradient descent (SGD), momentum, Nesterov accelerate gradient (NAG), Adagrad, AdaDelta, RMSProp, Adam, and Nadam.

The GD is a technique that adjusts model parameters in a direction to reduce the loss function value by considering the gradient of the loss function in the current state.

The direction in which the model parameter is adjusted is referred to as a step direction, and the size to be adjusted is referred to as a step size.

In this case, the step size may refer to a learning rate.

In the GD method, the gradient is obtained by partial differentiation of the loss function into each model parameter, and the model parameters may be updated by changing the learning rate in the obtained gradient direction.

The SGD method is a technique that increases the frequency of GD by dividing the training data into mini-batch and performing GD for each mini-batch.

The Adagrad, the AdaDelta, and the RMSProp are techniques to increase optimization accuracy by adjusting the step size in SGD. In the SGD, momentum and NAG are techniques to increase optimization accuracy by adjusting the step direction. The Adam is a technique to increase optimization accuracy by adjusting the step size and step direction by combining momentum and RMSProp. The Nadam is a technique to increase optimization accuracy by adjusting the step size and step direction by combining NAG and RMSProp.

The learning speed and accuracy of the ANN largely depend on hyperparameters as well as the structure of the ANN and the type of learning optimization algorithm. Therefore, in order to obtain a good learning model, it is important not only to determine an appropriate ANN structure and learning algorithm, but also to set appropriate hyperparameter.

Typically, hyperparameter is set to various values experimentally to train the ANN. As a result of learning, hyperparameter is set to optimal values that provide stable learning speed and accuracy.

Object detection models using machine learning include a single-step “you Only Look Once (YOLO)” model and a two-step “Faster Regions with Convolution Neural Networks (R-CNN)” model.

The YOLO model is a model in which an object existing in an image and a location of the object can be predicted by viewing the image only once.

The YOLO model divides original image into grids of equal size. For each grid, the number of bounding boxes designated in a predefined form around the center of the grid is predicted, and reliability is calculated based on this.

After that, whether the image includes an object or a background alone is included, and a location with high object reliability is selected, so that the object category can be identified.

The faster R-CNN model is a model that can detect objects faster than the RCNN model and the fast RCNN model.

The faster R-CNN model will be described in detail.

First, a feature map is extracted from an image through a CNN model. Based on the extracted feature map, a plurality of regions of interest (RoIs) are extracted. RoI pooling is performed for each RoI.

RoI pooling is a process of setting the grid so that the feature map on which the RoI is projected fits to a predetermined H×W size, extracting the largest value for each cell included in each grid, and extracting a feature map with the H×W size.

A feature vector may be extracted from the feature map having the H×W size, and identification information of the object may be obtained from the feature vector.

### Robot

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

A robot includes a driver including an actuator or a motor and may perform various physical operations such as moving a robot joint. In addition, a movable robot may include a wheel, a brake, a propeller, and the like in a driver, and may travel on the ground through the driver or fly in the air.

### Self-Driving

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

### eXtended Reality (XR)

Extended reality is collectively referred to as virtual reality (VR), augmented reality (AR), and mixed reality (MR).

The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

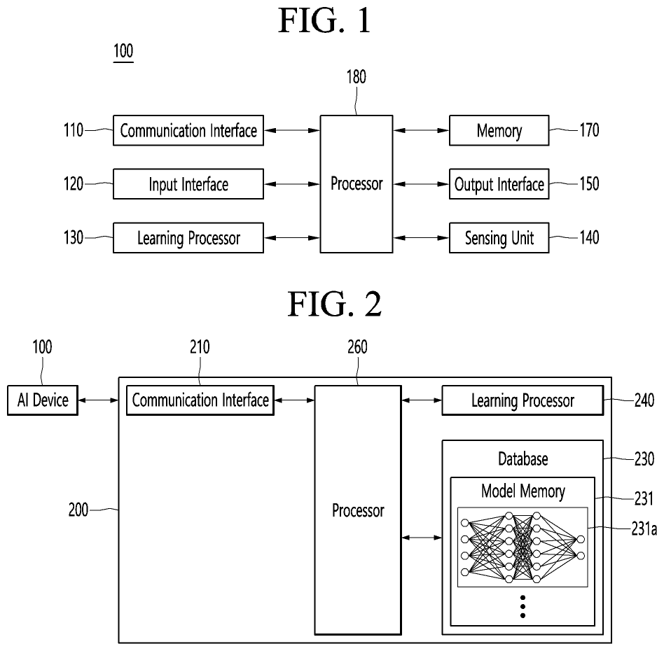

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication interface 110, an input interface 120, a learning processor 130, a sensor 140, an output interface 150, a memory 170, and a processor 180.

The communication interface 110 may transmit and receive data to and from external devices such as other AI devices 100a to 100e or an AI server 200 by using wire/wireless communication technology. For example, the communication interface 110 may transmit and receive sensor information, a user input, a learning model, and a control signal to and from external devices.

The communication technology used by the communication interface 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

At this time, the input interface 12 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 12 may acquire a learning data for model learning and an input data to be used when an output is acquired by using learning model. The input interface 12 may acquire raw input data. In this case, the processor 180 or the learning processor 130 may extract an input feature by preprocessing the input data.

The learning processor 130 may learn a model composed of an ANN by using training data. The learned ANN may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensor 140 may acquire at least one of internal information about the AI device 100, ambient environment information about the AI device 100, and user information by using various sensors.

Examples of the sensors included in the sensor 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

At this time, the output interface 150 may include a display for outputting time information, a speaker for outputting auditory information, and a haptic actuator for outputting haptic information.

The memory 170 may store data that supports various functions of the AI device 100. For example, the memory 170 may store input data acquired by the input interface 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intent information for the user input and may determine the user's requirements based on the acquired intent information.

At this time, the processor 180 may acquire the intent information corresponding to the user input by using at least one of a speech to text (STT) engine for converting speech input into a text string or a natural language processing (NLP) engine for acquiring intent information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI device 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an ANN by using a machine learning algorithm or uses a learned ANN. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication interface 21, a memory 230, a learning processor 240, a processor 260, and the like.

The communication interface 210 can transmit and receive data to and from an external device such as the AI device 100.

The memory 230 may include a model memory 231. The model memory 231 may store a learning or learned model (or an ANN 231a) through the learning processor 240.

The learning processor 240 may learn the ANN 231b by using the training data. The learning model may be used in a state of being mounted on the AI server 200 of the ANN, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 can infer a result value for new input data by using the learning model and generate a response or a control command based on the inferred result value.

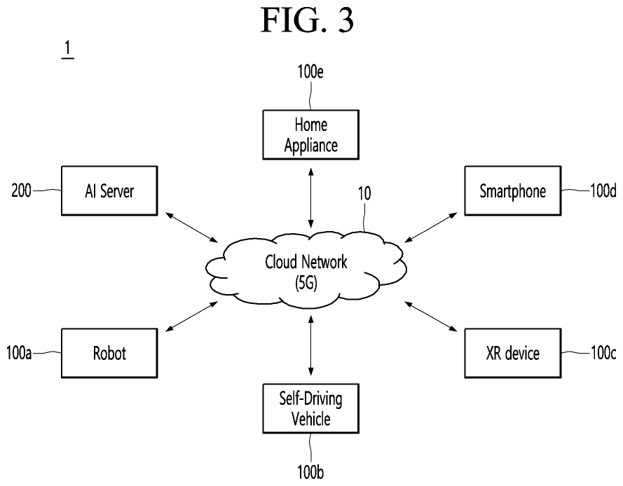

FIG. 3 illustrates an AI system 1 according to the embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the ANN according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

### AI+Robot

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external device to determine the travel route and the travel plan, and may control the driver such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driver based on the control/interaction of the user. At this time, the robot 100a may acquire the intention information of the interaction due to the user's operation or speech utterance, and may determine the response based on the acquired intention information, and may perform the operation.

### AI+Self-Driving

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driver such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driver based on the control/interaction of the user. At this time, the self-driving vehicle 100b may acquire the intention information of the interaction due to the user's operation or speech utterance, and may determine the response based on the acquired intention information, and may perform the operation.

### AI+XR

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

### AI+Robot+Self-Driving

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driver of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

### AI+Robot+XR

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

### AI+Self-Driving+XR

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. On the other hand, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

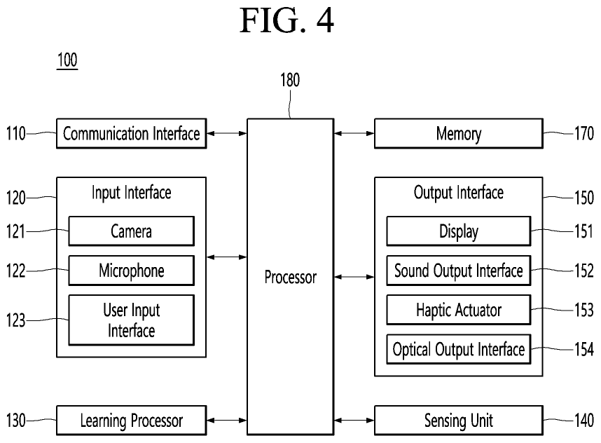

FIG. 4 illustrates an AI device 100 according to an embodiment of the present disclosure.

A description overlapping FIG. 1 will be omitted.

Referring to FIG. 4, the input interface 120 may include a camera 121 for receiving a video signal, a microphone 122 for receiving an audio signal, and a user input interface (user input unit) 123 for receiving information from a user.

Voice data or image data collected by the input interface 120 may be analyzed and processed as a user control command.

The input interface 120 is configured to input image information (or signal), audio information (or signal), data, or information input from a user. For input of image information, the AI device 100 may include one or a plurality of cameras 121.

The camera 121 processes image frames of still images or moving images obtained by image sensors in a video call more or an image capture mode. The processed image frames may be displayed on the display (display unit) 151 or stored in memory 170.

The microphone 122 processes an external sound signal into electrical voice data. The processed voice data may be utilized in various ways according to a function being executed by the AI device 100 (or a running application program). On the other hand, various noise cancellation algorithms for canceling noise generated in a process of receiving an external sound signal may be applied to the microphone 122.

The user input interface 123 receives information from a user. When information is received through the user input interface 123, the processor 180 may control operation of the AI device 100 in correspondence with the input information.

The user input interface 123 may include a mechanical input element (for example, a mechanical key, a button located on a front and/or rear surface or a side surface of the AI device 100, a dome switch, a jog wheel, a jog switch, and the like) or a touch input element. As one example, the touch input element may be a virtual key, a soft key or a visual key, which is displayed on a touchscreen through software processing, or a touch key located at a location other than the touchscreen.

The output interface 150 may include a display (display unit) 151, a sound output interface (sound output unit) 152, a haptic actuator (haptic module) 153, and an optical output interface (optical output unit) 154.

The display 151 displays (outputs) information processed by the AI device 100. For example, the display 151 may display execution screen information of an application program driven in the AI device 100 or user interface (UI) and graphic user interface (GUI) information according to the execution screen information.

The display 151 may implement a touch screen by forming a mutual layer structure with the touch sensor or being integrally formed with the touch sensor. The touch screen may function as the user input interface 123 providing an input interface between the AI device 100 and the user, and may also provide an output interface between the AI device 100 and the user.

The sound output interface 152 may output audio data received from the communication interface 110 or stored in the memory 170 in a call signal reception mode, a call mode, a record mode, a voice recognition mode, a broadcast reception mode, and the like.

The sound output interface 152 may include at least one of a receiver, a speaker, or a buzzer.

The haptic actuator 153 generates various tactile effects that a user feels. A representative example of a tactile effect generated by the haptic actuator 153 is vibration.

The optical output interface 154 may output a signal for indicating event generation using light of a light source of the AI device 100. Examples of events generated in the AI device 100 may include message reception, call signal reception, a missed call, an alarm, a schedule notice, email reception, information reception through an application, and the like.

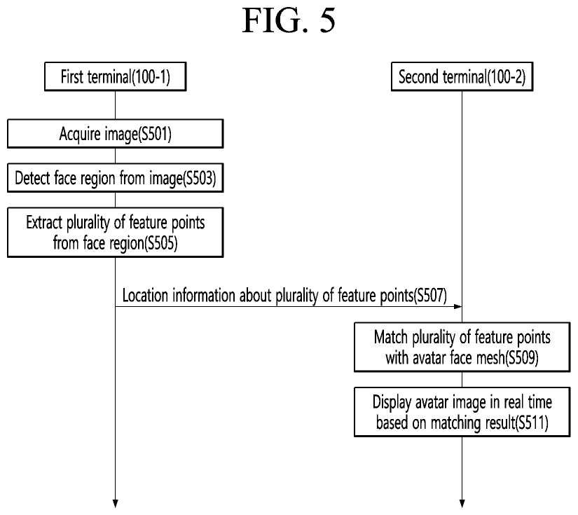

FIG. 5 is a ladder diagram for describing an operating method of a system according to an embodiment of the present disclosure.

Referring to FIG. 5, the system may include a first terminal 100-1 and a second terminal 100-2.

The first terminal 100-1 and the second terminal 100-2 may be edge devices for a video conference in the metaverse.

Each of the first terminal 100-1 and the second terminal 100-2 may include all of the components of FIG. 4. That is, each of the first terminal 100-1 and the second terminal 100-2 may be the AI device 100 of FIG. 4.

In another embodiment, the first terminal 100-1 may be a camera device having a camera 121, and the second terminal 100-2 may be a PC.

The processor 180 of the first terminal 100-1 acquires an image through the camera 121 (S501).

The camera 121 may be separately provided and connected to the first terminal 100-1.

When the first terminal 100-1 is a camera device and the second terminal 100-2 is a PC, the two devices may be connected through a USB or a wireless communication standard.

The processor 180 of the first terminal 100-1 detects a face region from the acquired image (S503).

In an embodiment, the processor 180 may detect a face region from an image using a well-known deep learning-based face recognition algorithm.

As the well-known deep learning-based face recognition algorithm, Openface may be used.

Openface may be a framework for implementing facial behavior analysis algorithms including facial landmark detection, head posture tracking, gaze, and face action unit recognition.

The processor 180 may detect the face region in real time from the image frame acquired by the camera 121.

The processor 180 of the first terminal 100-1 extracts a plurality of feature points from the detected face region (S505).

The processor 180 may extract a plurality of feature points characterizing the face region from the detected face region.

The processor 180 may extract a preset number of feature points from the face region. The preset number may be 128, but this is only an example.

The processor 180 may extract a plurality of 3D face landmarks indicating a plurality of feature points by using a deep learning algorithm of a 2D face landmark detection method or a 3D face landmark detection method.

Each landmark may be expressed as three-dimensional x, y, and z values. The x and y values represent the width and height of the landmark, and may be normalized to [0.0, 1.0] by the overall width and height of the image.

The z value represents the depth of the landmark with the depth of the center of the head as the origin, and the value may decrease as the landmark is closer to the camera 121.

The processor 180 may extract a preset number of feature points from the image frame and obtain location information of each extracted feature point.

Each location information may be expressed as x, y, and z coordinate values.

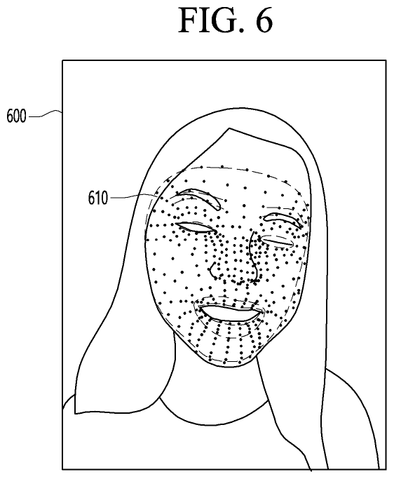

FIG. 6 is a view for describing a process of extracting a plurality of feature points from an image, according to an embodiment of the present disclosure.

Referring to FIG. 6, an image 600 captured by the camera 121 is shown.

The processor 180 may detect a face region 610 from the image 600 and extract a preset number of feature points from the detected face region 610.

Each feature point may be a point characterizing each of the forehead region, cheek region, eye region, nose region, mouth region, and chin region constituting the face region.

Again, FIG. 5 is described.

The processor 180 of the first terminal 100-1 transmits location information about a plurality of feature points to the second terminal 100-2 through the communication interface 110 (S507).

The processor 180 may transmit location information about each of the preset number of feature points to the second terminal 100-2 in real time.

The preset number may be 128. The reason why only the location information about the preset number of feature points is transmitted is that, if the number of feature points increases, the amount of data to be transmitted increases, which may cause a delay in the display of the avatar image corresponding to the user's image.

The processor 180 of the second terminal 100-2 matches the plurality of feature points with an avatar face mesh based on the received location information about the plurality of feature points (S509).

The avatar face mesh may represent a structure representing the face of the avatar.

The avatar face mesh may be composed of a plurality of landmarks.

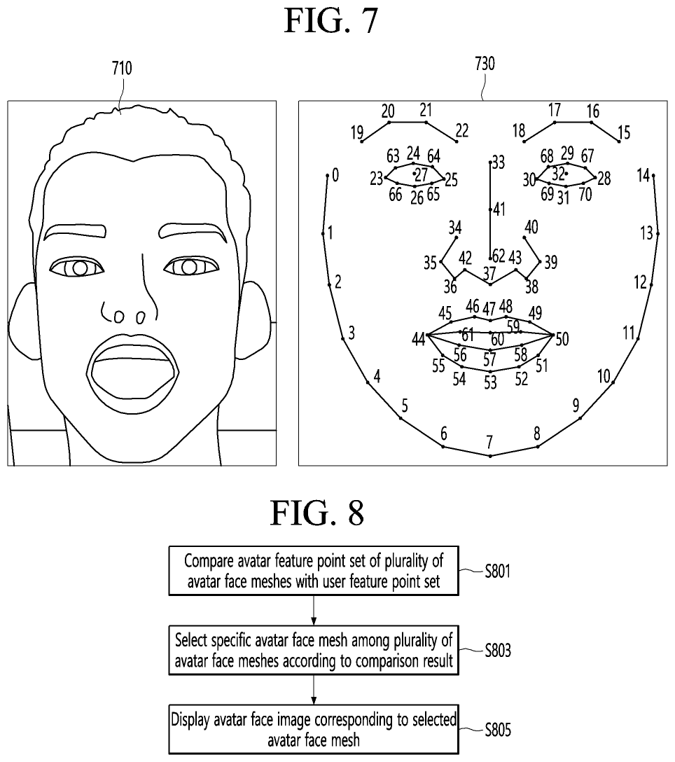

The avatar face mesh will be described with reference to FIG. 7.

FIG. 7 is a view for describing the avatar face mesh according to an embodiment of the present disclosure.

Referring to FIG. 7, an avatar face image 710 and an avatar face mesh 730 corresponding to the avatar face image 710 are shown.

The memory 170 may store the avatar face image 710 and the avatar face mesh 730 corresponding to the avatar face image 710.

In addition, the memory 170 may store location information of each of a plurality of landmarks constituting the avatar face mesh 730.

Again, FIG. 5 is described.

The memory 170 of the second terminal 100-2 may store a plurality of avatar face meshes for one avatar. Specifically, the memory 170 may store location information (coordinate information) of each of a plurality of landmarks constituting each avatar face mesh.

The processor 180 of the second terminal 100-2 may compare the received user feature point set including the plurality of feature points with the avatar feature point set corresponding to each of the plurality of avatar face meshes.

That is, this comparison process may be a matching process.

The processor 180 of the second terminal 100-2 displays the avatar image on the display 151 in real time based on the matching result (S511).

Operations S509 and S511 will be described with reference to FIG. 8.

FIG. 8 is a flowchart for describing a process of determining an avatar face mesh matching a user feature point set and displaying an avatar face image corresponding to the determined avatar face mesh, according to an embodiment of the present disclosure.

Referring to FIG. 8, the processor 180 of the second terminal 100-2 compares the avatar feature point set of each of the plurality of avatar face meshes with the user feature point set (S801).

The avatar feature point set may include location information about a plurality of landmarks (a plurality of avatar feature points) constituting the avatar face mesh.

The user feature point set may include location information about a plurality of feature points received from the first terminal 100-1.

The processor 180 of the second terminal 100-2 selects a specific avatar face mesh among the plurality of avatar face meshes according to the comparison result (S803).

The processor 180 may compare the similarity between each of the plurality of avatar feature point sets and the user feature point set, and extract the avatar feature point set having the greatest similarity.

The processor 180 may extract an avatar feature point set having a minimum difference in coordinates between user feature points at locations corresponding to the avatar feature points.

The processor 180 may select an avatar face mesh corresponding to the extracted avatar feature point set as a mesh for reflecting the avatar face.

In another embodiment, the processor 180 may select a matching avatar face mesh through similarity comparison between feature points included in a specific region among the plurality of region regions included in the face region.

For example, the processor 180 may select an avatar face mesh that matches the feature points included in the nose region through similarity comparison between feature points included in the nose region of the avatar face mesh.

The processor 180 of the second terminal 100-2 displays the avatar face image corresponding to the selected avatar face mesh on the display 151 in real time (S805).

The processor 180 of the second terminal 100-2 may reflect the change in the user's face acquired through the camera 121 through the avatar face image in real time.

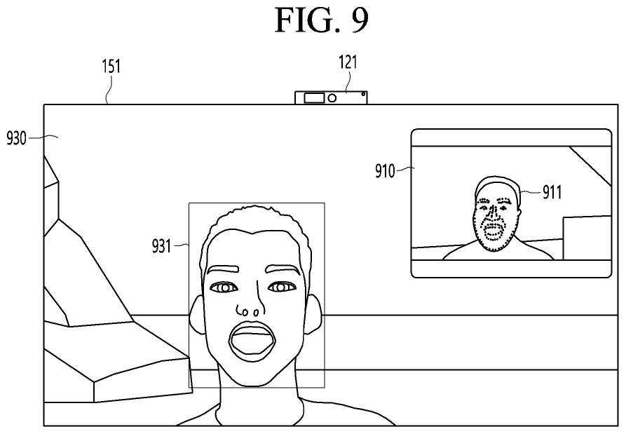

FIG. 9 is a view for describing an example of reflecting the change in the obtained user face through the avatar face image in real time, according to an embodiment of the present disclosure.

Referring to FIG. 9, the camera 121 may photograph a user. The display 151 of the second terminal 100-2 may display an image 910 captured by the camera 121.

The captured image 910 may include a user face image 911.

The display 151 may display a metaverse image 930. The metaverse image 930 may include an avatar face image 931.

The user face image 911 may be displayed while overlapping on the metaverse image 930.

The avatar face image 931 may reflect the change in the user face image 911 in real time. For example, when the user takes the action to open the mouth, the avatar may also take the action to open the mouth.

As described above, according to an embodiment of the present disclosure, the change in the user face is reflected on the avatar's face in real time, so that the user may feel more realistic in the metaverse.

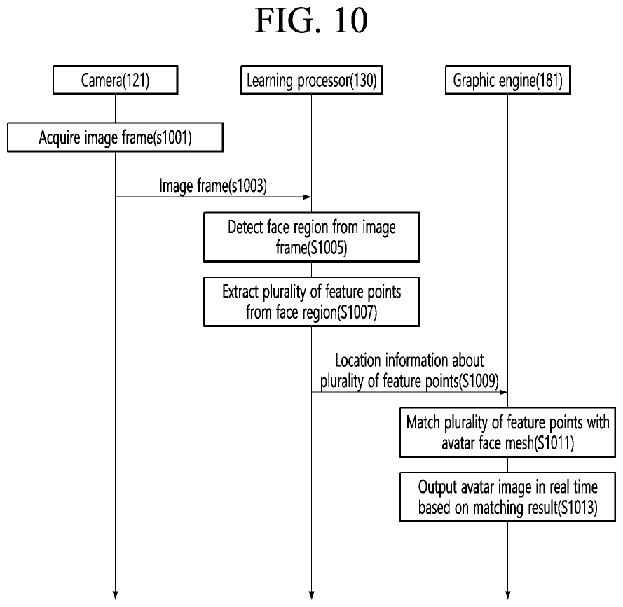

FIG. 10 is a view for describing the operating method of the AI device according to an embodiment of the present disclosure.

In an embodiment, the graphic engine 181 may be a component provided separately from the processor 180.

The learning processor 130 may be a component included in the processor 180.

The camera 121 of the AI device 100 acquires an image frame including a user face image (S1001).

The camera 121 may be included in the AI device 100 or may be connected to the AI device 100 through a USB.

The learning processor 130 of the AI device 100 transmits the acquired image frame to the learning processor 130 (S1003).

The learning processor 130 of the AI device 100 detects a face region from the acquired image frame (S1005).

The learning processor 130 may detect a face region from an image using a well-known deep learning-based face recognition algorithm.

As the well-known deep learning-based face recognition algorithm, Openface may be used.

Openface may be a framework for implementing facial behavior analysis algorithms including facial landmark detection, head posture tracking, gaze, and face action unit recognition.

The learning processor 130 may detect the face region in real time from the image frame acquired by the camera 121.

The learning processor 130 of the AI device 100 extracts a plurality of feature points from the detected face region (S1007).

The learning processor 130 may extract a plurality of feature points characterizing the face region from the detected face region.

The learning processor 130 may extract a preset number of feature points from the face region. The preset number may be 128, but this is only an example.

The learning processor 130 may detect a face region from one image frame and extract 128 feature points from the detected face region.

The learning processor 130 may extract a plurality of 3D face landmarks indicating a plurality of feature points by using a deep learning algorithm of a 2D face landmark detection method or a 3D face landmark detection method.

Each landmark may be expressed as three-dimensional x, y, and z values. The x and y values represent the width and height of the landmark, and may be normalized to [0.0, 1.0] by the overall width and height of the image.

The z value represents the depth of the landmark with the depth of the center of the head as the origin, and the value may decrease as the landmark is closer to the camera 121.

The learning processor 130 may extract a preset number of feature points from the image frame and obtain location information of each extracted feature point.

Each location information may be expressed as x, y, and z coordinate values. The description of the process of extracting the plurality of feature points from the image frame is replaced with the description of FIG. 6.

The learning processor 130 of the AI device 100 transmits location information about the plurality of feature points to the graphic engine 181 (S1009).

The learning processor 130 may transmit location information about each of the preset number of feature points to the graphic engine 181 in real time.

The preset number may be 128. The reason why only the location information about the preset number of feature points is transmitted is that, if the number of feature points increases, the amount of data to be transmitted increases, which may cause a delay in the display of the avatar image corresponding to the user's image.

The graphic engine 181 of the AI device 100 matches the plurality of feature points with the avatar face mesh based on the location information about the plurality of feature points (S1011).

The avatar face mesh may represent a structure representing the face of the avatar.

The avatar face mesh may be composed of a plurality of landmarks.

The description of the avatar face mesh is replaced with the description of FIG. 7.

The memory 170 of the AI device 100 may store the plurality of avatar face meshes for one avatar. Specifically, the memory 170 may store location information (coordinate information) of each of a plurality of landmarks constituting each avatar face mesh.

The processor 180 of the AI device 100 may compare the received user feature point set including the plurality of feature points with the avatar feature point set corresponding to each of the plurality of avatar face meshes.

That is, this comparison process may be a matching process.

The graphic engine 181 of the AI device 100 outputs an avatar image to the display 151 in real time based on the matching result (S1013).

The graphic engine 181 of the AI device 100 may compare the avatar feature point set of each of the plurality of avatar face meshes with the user feature point set.

The avatar feature point set may include location information about a plurality of landmarks (a plurality of avatar feature points) constituting the avatar face mesh.

The user feature point set may include location information about the plurality of feature points received from the learning processor 130.

The graphic engine 181 of the AI device 100 may select a specific avatar face mesh among the plurality of avatar face meshes according to the comparison result.

The graphic engine 181 of the AI device 100 may compare the similarity between each of the plurality of avatar feature point sets and the user feature point set, and extract the avatar feature point set having the greatest similarity.

The graphic engine 181 of the AI device 100 may select an avatar face mesh corresponding to the extracted avatar feature point set as a mesh for reflecting the avatar face.

The graphic engine 181 of the AI device 100 may output an avatar face image corresponding to the selected avatar face mesh on the display 151 in real time.

The display 151 may display the avatar face image changing according to the change in the user face in real time.

According to an embodiment of the present disclosure, the avatar image may be displayed without delay as only a preset number of feature points from the detected user face region are used and reflected in the avatar.

According to an embodiment of the present disclosure the user face is reflected on the avatar's face in real time, so that the user may feel more realistic in the metaverse.

The present disclosure described above may be embodied as computer-readable code on a medium on which a program is recorded. A computer-readable medium includes any types of recording devices in which data readable by a computer system is stored. Examples of the computer-readable medium include hard disk drive (HDD), solid state disk (SSD), silicon disk drive (SDD), ROM, RAM, CD-ROM, magnetic tape, floppy disk, optical data storage device, and the like. In addition, the computer may include the processor 180 of the AI device.

What is claimed is:

1. An artificial intelligence device comprising:
a display;
a graphic engine; and
one or more processors configured to:
detect a user's face region from an image received from a camera,
extract a preset number of feature points from the detected face region, and
transmit information about the extracted feature points to the graphic engine,
wherein the graphic engine is configured to output, for output via the display, an avatar face image corresponding to the face region based on the information about the extracted feature points.

2. The artificial intelligence device of claim 1, wherein the information about the feature points includes location information of each of the feature points located in the face region.

3. The artificial intelligence device of claim 2, wherein the location information includes one of three-dimensional x, y, and z coordinate values or two-dimensional x and y coordinate values.

4. The artificial intelligence device of claim 2, further comprising a memory configured to store a plurality of avatar face meshes corresponding to a plurality of avatar face images,
wherein the graphic engine is further configured to compare the location information with location information of avatar feature points corresponding to the plurality of avatar face meshes stored in the memory, and select a specific avatar face mesh based on the comparison.

5. The artificial intelligence device of claim 4, wherein the selected specific avatar face mesh is used to output the avatar face image.

6. The artificial intelligence device of claim 5, wherein the display is configured to display the avatar face image output from the graphic engine in real time with receiving the image from the camera.

7. The artificial intelligence device of claim 6, wherein the display is configured to also display the image received from the camera.

8. An operating method of an artificial intelligence device, the operating method comprising:
detecting a user's face region from an image received from a camera;
extracting a preset number of feature points from the detected face region;
transmitting information about the extracted feature points to a graphic engine; and
outputting, via a display, an avatar face image corresponding to the face region based on the information about the extracted feature points.

9. The operating method of claim 8, wherein the information about the feature points includes location information of each of the feature points located in the face region.

10. The operating method of claim 9, wherein the location information includes one of three-dimensional x, y, and z coordinate values or two-dimensional x and y coordinate values.

11. The operating method of claim 9, further comprising:
comparing the location information with location information of avatar feature points corresponding to the plurality of avatar face meshes stored in a memory; and
selecting a specific avatar face mesh based on the comparison.

12. The operating method of claim 11, wherein the selected specific avatar face mesh is used to output the avatar face image.

13. The operating method of claim 12, wherein displaying the output avatar face image is in real time with receiving the image from the camera.

14. The operating method of claim 13, further comprising also displaying the image received from the camera.
